(19) United States
(12) Patent Application Publication
(10) Pub. No.: US 2025/0087435 A1
(43) Pub. Date: Mar. 13, 2025

(54) PUSH-BUTTON AND ELECTRICAL SYSTEM COMPRISING THE SAME

(71) Applicant: Schneider Electric Industries SAS, Rueil Malmaison (FR)

(72) Inventor: Thierry Fort, Gimeux (FR)

(73) Assignee: Schneider Electric Industries SAS, Rueil Malmaison (FR)

(21) Appl. No.: 18/813,288

(22) Filed: Aug. 23, 2024

(30) Foreign Application Priority Data
Sep. 7, 2023 (EP) 23306483.1

(51) Int. Cl. H01H 13/62; H01H 13/04; H01H 13/28

(52) U.S. Cl. CPC H01H 13/62; H01H 13/04; H01H 13/28

(57) ABSTRACT

A push-button (100) includes a plunger sub-assembly (10) that comprises a translation-to-rotation converting part (5), a latch part (6) and a latch spring element (56). The latch spring element connects the latch part to the translation-to-rotation converting part so that rotation of the translation-to-rotation converting part caused by a user pressing the push-button drives the latch part into a position where said latch part abuts a relief portion in the internal surface of a casing (30) of the push-button. Such arrangement of the plunger sub-assembly avoids that numerous repeated locking operations damage to the latch part and/or relief portion. Lifetime of the push-button is thus increased.

The invention relates to a push-button and an electrical system that comprises such push-button.

### BACKGROUND OF THE INVENTION

Push-buttons are used for maintaining in pressed position actuators which are spring-loaded. An important application is to provide shutdown keys to electrical systems, in particular for meeting security requirements.

Two types of locking mechanisms are used for maintaining a push-button in pressed position.

The first type implements balls or fingers which are radially pushed outwards into recesses by springs, as disclosed for example in EP 1 261 978 B1. But edges of the recesses become worn after a number of locking and unlocking operations, which causes reliability of the push-button to decline over its lifetime. Furthermore, one or two radial force(s) may be involved in this locking mechanism type that can cause at least some of the constituting elements of the push-button to misalign with respect to others. Jamming of the push-button then occurs, resulting again into reduced reliability of its operation.

The second type of locking mechanisms implements rotation of a cylinder provided with a protruding rim segment so that the rim segment is retained by a fixed relief element against back-translation driven by a pull-back spring. But the rim segment repeatedly bumping into the relief element alters the shapes of these parts, causing the push-button to no longer operate properly.

Starting from this situation, the present invention aims at providing a new push-button in which the above issues are alleviated or solved.

In particular, one object of the invention consists in providing a push-button which exhibits reliable operation over increased lifetime.

An additional object of the invention is to provide push-buttons which can be unlocked either through rotation only, or through both rotation or pulling action, executed by a user.

Another additional object of the invention consists in reducing potential for jamming which could disrupt the operation of the push-button.

### SUMMARY OF THE INVENTION

For meeting at least one of these objects or others, a first aspect of the present invention proposes a push-button adapted for being pressed by a user parallel to a pressing direction, and for remaining in a locked pressed position until an unlocking action is executed by the user. In the invention push-button, at least part of a plunger sub-assembly is driven into rotation by the user pressing a push-head of the push-button and the rotated part of the plunger sub-assembly then abuts a relief portion existing in an internal surface of a casing of the push-button, thereby producing locking of the pressed position.

According to the invention, the plunger sub-assembly comprises:
a translation-to-rotation converting part, adapted for being rotated by the user pressing the push-head;
a latch part, having an edge arranged for abutting the relief portion in the internal surface of the casing so as to produce locking of the pressed position; and
a latch spring element separated from the translation-to-rotation converting part, and connecting the latch part to the translation-to-rotation converting part so that rotation of the translation-to-rotation converting part drives the latch part, through the latch spring element, into a position that leads to abutment of the latch part against the relief portion in the internal surface of the casing.

Thanks to the latch spring element acting intermediate between the translation-to-rotation converting part and the latch part, bumping of the latch part into the relief portion is reduced, so that the push-button remains reliable over an increased lifetime. Appropriate selection of the latch spring element produces calibrated bumping and abutment force of the latch part onto the relief portion, thereby avoiding damage to the latch part and/or relief portion that might cause otherwise numerous repeated locking operations.

In possible embodiments of the invention, the push-button may further comprise a pull-back spring intermediate between the push-head and the casing of the push-button, the pull-back spring being arranged so that the user pressing the push-head causes compression of this pull-back-spring. Then, the compressed pull-back spring may complete driving action of the latch spring element for producing the abutment of the latch part against the relief portion in the internal surface of the casing.

In particular, the pull-back spring may drive the push-button from a stop position where the push-head has been pressed at maximum depth to the locked position where the latch part actually abuts the relief portion.

The user pressing the push-head causes the plunger sub-assembly to translation-move in the pressing direction. Then, the plunger sub-assembly may comprise the following parts:
a center plunger, which is arranged for receiving a pressing force due to the user pressing the push-head, and for driving the plunger sub-assembly into translation movement;
the translation-to-rotation converting part, which is arranged around the center plunger and rotatable relative to the center plunger;
the latch part, which is also arranged around the center plunger and rotatable relative to the center plunger; and
the latch spring element.

With such arrangement, the center plunger, the translation-to-rotation converting part, the latch part and the latch spring element all execute a same translation movement component parallel to the pressing direction when the user presses the push-head. Preferably, the latch spring element may be a torsion spring which has turns arranged around the center plunger, between the translation-to-rotation converting part and the latch part.

In first embodiments of the invention that implement the pull-back spring and the plunger sub-assembly composition as just mentioned, the edge of the latch part is perpendicular to the pressing direction and extends between a re-entrant corner of this latch part and an escape end of the edge. With such configuration, the locked pressed position is produced by the abutment of the edge of the latch part at the re-entrant corner against an apex of the relief portion in the internal surface of the casing. From this locked pressed position, a counter-rotation of the center plunger can cause the latch part to rotation-slip on the relief portion until the escape end reaches the apex of this relief portion, thus allowing the pull-back spring to pull the center plunger in a pull-back direction opposite the pressing direction. With such first embodiments, unlocking of the push-button can only be executed through counter-rotation of the push-head applied by the user. The push-head may be arranged to contact the center plunger so that the counter-rotation applied to this push-head by the user is transmitted to the center plunger.

Still for these first embodiments of the invention, the center plunger may be provided with a counter-slanted edge which is arranged for contacting another relief portion existing in the internal surface of the casing. Then, the pull-back spring pulling the center plunger in the pull-back direction causes the center plunger to rotate. This is achieved by means of the counter-slanted edge slipping on the so-called another relief portion, against a return force which is produced by the latch spring element. Preferably, the relief portion and the so-called another relief portion may belong to a same relief element located in the internal surface of the casing. In such case, the counter-slanted edge of the center plunger may be arranged so that, when the pull-back spring pulls the plunger sub-assembly in the pull-back direction, the latch part and a forward portion of the center plunger that supports the counter-slanted edge both simultaneously slip along the relief element, on opposed edges of this relief element. During such movement, the latch spring element makes the latch part and the forward portion of the center plunger to pressure-sandwich the relief element.

In second embodiments of the invention that also implement the pull-back spring and the above-recited plunger sub-assembly composition, the edge of the latch part is slanted with respect to the pressing direction but extends again between a re-entrant corner of this latch part and an escape end of the edge. With such alternative configuration, the locked pressed position is produced again by the abutment of the edge of the latch part at the re-entrant corner against the apex of the relief portion in the internal surface of the casing. From this locked pressed position, a translation shift of the center plunger in a pull-back direction opposite the pressing direction can cause the latch part to rotation-slip on the relief portion until the escape end reaches the apex of this relief portion. This allows the pull-back spring to further pull the plunger sub-assembly in the pull-back direction. With such second embodiments, unlocking of the push-button can be executed through either counter-rotation or pulling of the push-head applied by the user. The push-head may be arranged to contact the center plunger so that a pull-shift applied to this push-head by the user is transmitted to the center plunger, so as to cause this latter to translate in the pull-back direction.

Generally for the invention, the push-button may further comprise a trigger spring which is intermediate between the push-head and the plunger sub-assembly, and arranged for transmitting at least part of a translation movement which is applied by the user to the push-head, in the pressing direction, to the plunger sub-assembly. Such trigger spring avoids that the plunger sub-assembly bumps with excessive strength into a stop portion of the casing under pressing action by the user onto the push-head. In this way, bumps repeated numerous times can no longer damage the plunger sub-assembly and/or the stop portion of the casing.

Again generally for the invention, the push-head, the plunger sub-assembly and the internal surface of the casing may be designed for remaining identical through rotations of 120° about an axis that is parallel to the pressing direction. This ensures that all elements of the push-button that are mobile remain parallel when moving, thus avoiding any jamming of the push-button. Put another way, such design that remains identical through 120°-rotations provides isostatic equilibrium for the constituting elements of the push-button, thereby avoiding that some of them misalign with respect to others.

A second aspect of the invention proposes an electrical system, which comprises a spring-loaded actuator designed for being operated through pressing onto this actuator by a user, and which further comprises a push-button according to the first invention aspect. The push-button is arranged overtop the actuator so as to provide a locking function to a pressed state of the actuator. The actuator and the push-button may form together a shutdown key of the electrical system.

These and other features of the invention will be now described with reference to the appended figures, which relate to preferred but not-limiting embodiments of the invention.

### BRIEF DESCRIPTION OF THE DRAWINGS

FIG. 1a is an exploded perspective view of parts of a push-button according to the invention.

FIG. 1b is an enlargement of a relief element provided in one of the parts of the push-button of FIG. 1a.

FIG. 2a is a perspective view of the push-button of FIG. 1a in an off position.

FIG. 2b is an enlargement of part of the push-button of FIG. 1a, also relating to the off position of FIG. 2a.

FIGS. 3a and 3b correspond to FIGS. 2a and 2b, respectively, but for an activation position of the push-button.

FIGS. 4a and 4b also correspond to FIGS. 2a and 2b, respectively, but for a trigger position of the push-button.

FIGS. 5a and 5b also correspond to FIGS. 2a and 2b, respectively, but for a stop position of the push-button.

FIGS. 6a and 6b also correspond to FIGS. 2a and 2b, respectively, but for a locked position of the push-button.

FIGS. 7a and 7b also correspond to FIGS. 2a and 2b, respectively, but for a rotation-unlocked position of the push-button.

FIGS. 8a and 8b also correspond to FIGS. 2a and 2b, respectively, but for a rotation-unlocked position of the push-button.

FIGS. 9a and 9b correspond to FIGS. 6b and 7b, respectively, but for an alternative embodiment of the invention which can be unlocked through counter-rotation only.

FIG. 10 shows an electrical system according to the invention.

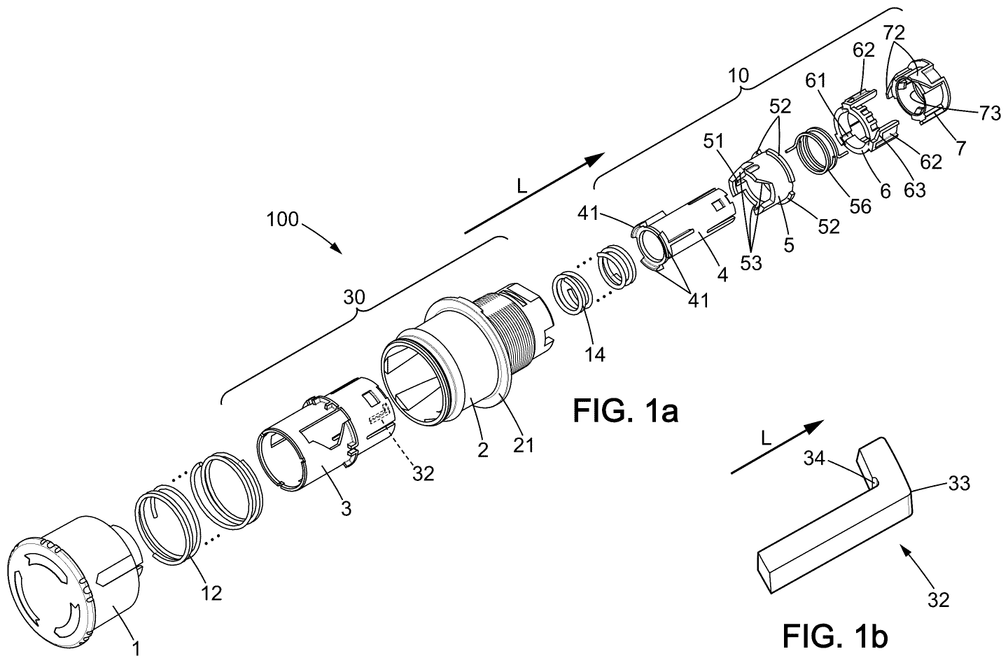

For clarity sake, element sizes which appear in these figures do not correspond to actual dimensions or dimension ratios. Also, same reference numbers which are indicated in different ones of these figures denote identical elements of elements with identical function.

### DETAILED DESCRIPTION OF THE INVENTION

In these figures, the reference numbers listed below denote the following constituting elements of the push-button 100:
1 push-head
2 mount housing
3 insert
4 plunger, also called center plunger in the general part of the description
5 cylinder, also called translation-to-rotation converting part in the general part of the description
6 latch part
7 ring, also called forward portion of the center plunger in the general part of the description
12 pull-back spring
14 trigger spring
56 latch spring, also called latch spring element in the general part of the description, for example embodied in the form of a multi-turn torsion spring
L longitudinal direction, corresponding to pressing direction for a user to activate the push-button

The insert 3 is fixed within the mount housing 2, and these insert 3 and mount housing 2 form together a casing 30 of the push-button 100.

The pull-back spring 12 is designed to move away from one another the push-head 1 and the casing 30 parallel to the longitudinal direction L.

The trigger spring 14 is designed to transmit a push-shift from the push-head 1 to the plunger 4.

The cylinder 5, the latch part 6 and the latch spring 56 are each arranged around the plunger 4. These elements together with the plunger 4 and the ring 7 constitute the plunger sub-assembly 10. Within this sub-assembly, the ring 7 is secured fixedly to the plunger 4, at a forward end thereof opposite the push-head 1. Such division between the plunger 4 and the ring 7 is optional but may be beneficial for assembling issue of the whole push-button 100. The cylinder 5 and the latch part 6 are each rotatable relative to the plunger 4, but without translational movement component being possible with respect to the plunger 4. The latch spring 56 angularly connects the cylinder 5 to the latch element 6. It is housed within the cylinder 5.

Other reference numbers also indicated in the figures have the following meanings:
11 protruding finger portion of the push-head 1, intended to cooperate with a slanted edge of the cylinder 5
21 peripheral stop ring of the mount housing 2
32 relief element in the internal surface of the insert 3, which is L-shaped in the embodiments described here, with long segment of the L-letter parallel to the longitudinal direction L and small transversal segment of the L-letter toward the ring 7
33 external apex of the relief element 32
34 internal apex of the relief element 32
41 radially protruding rim segment of the plunger 4
51 internal notch of the cylinder 5 for anchoring of a first end of the latch spring 56
52 radially-protruding rim segment of the cylinder 5
53 slanted edge of the cylinder 5, to be contacted by the finger portion 11 of the push-head 1
61 internal notch of the latch part 6 for anchoring of a second end of the latch spring 56
62 longitudinally-protruding portion of the latch part 6, extending parallel to the longitudinal direction L
63 edge of the latch part 6, to be contacted by the relief element 32 of the insert 3
64 stop end of the edge 63, in the form of a re-entrant corner
65 escape end of the edge 63
72 longitudinally-protruding portion of the ring 7, extending parallel to the longitudinal direction L
73 counter-slanted edge of the longitudinally-protruding portion 72

The portion element 32 which is implemented in the described embodiments gathers both so-called relief portion and so-called another relief portion as introduced in the general part of the description. The so-called relief portion is the part of the relief element 32 that cooperates with the latch part 6, and the so-called another relief portion is another part of the relief element 32 that cooperates with the ring 7.

Preferably, at least a forward portion of the push-head 1 which cooperates with the plunger sub-assembly 10, a portion of the internal surface of the insert 3 which contains the relief element 32, the cylinder 5, the latch part 6 and the ring 7 remain identical through 120°-rotations about a center axis of the push-button 100 which is parallel to the longitudinal direction L. Thus, the relief element 32, the portions 62 and 72, the finger portion 11, the slanted edge 53 and the rim segments 41 and 52 are each triplicated although the operation description is provided hereafter for a single set of these element parts.

Operation of the push-button 100 is now described.

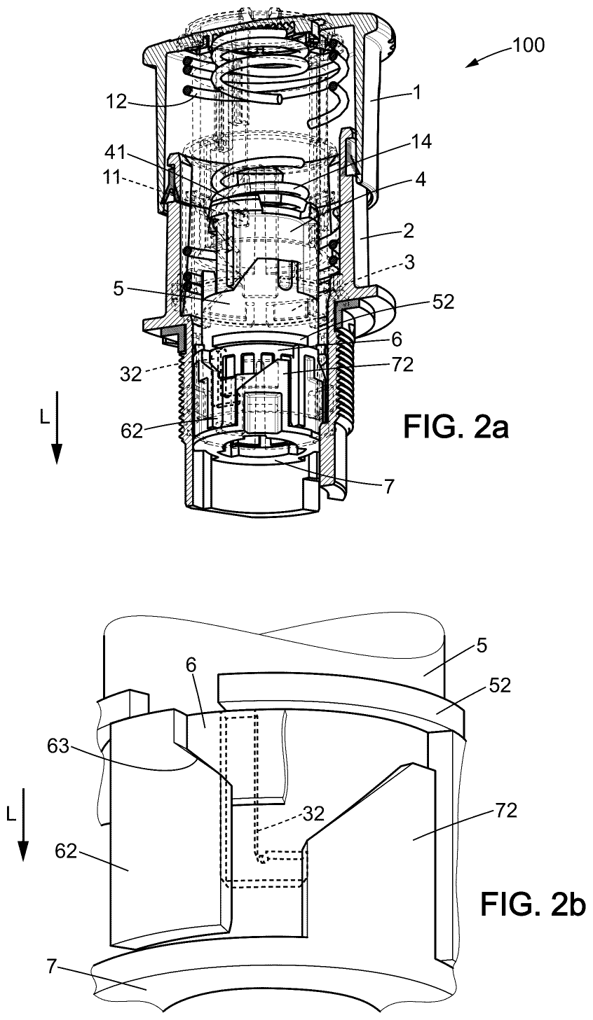

FIGS. 2a and 2b show a start position, referred to as off position of the push-button 100. In this position, the push-head 1 is maintained furthest from the casing 30 by the pull-back spring 12, and the plunger sub-assembly 10 is pulled at maximum shift length opposite the longitudinal direction L by the pull-back spring 12, via a dedicated finger portion provided in the forward portion of the push-head 1. To this purpose, this finger may releasably hook the rim segment 41 of the plunger 4. Possibly, this function may also be produced by the finger portion 11 of the push-head 1.

FIG. 2b shows that the small transversal segment of the relief element 32 is pinched between the portions 62 and 72 due to the latch spring 56, and the top of the L-letter shape of the relief element 32 is next to the rim segment 52 of the cylinder 5.

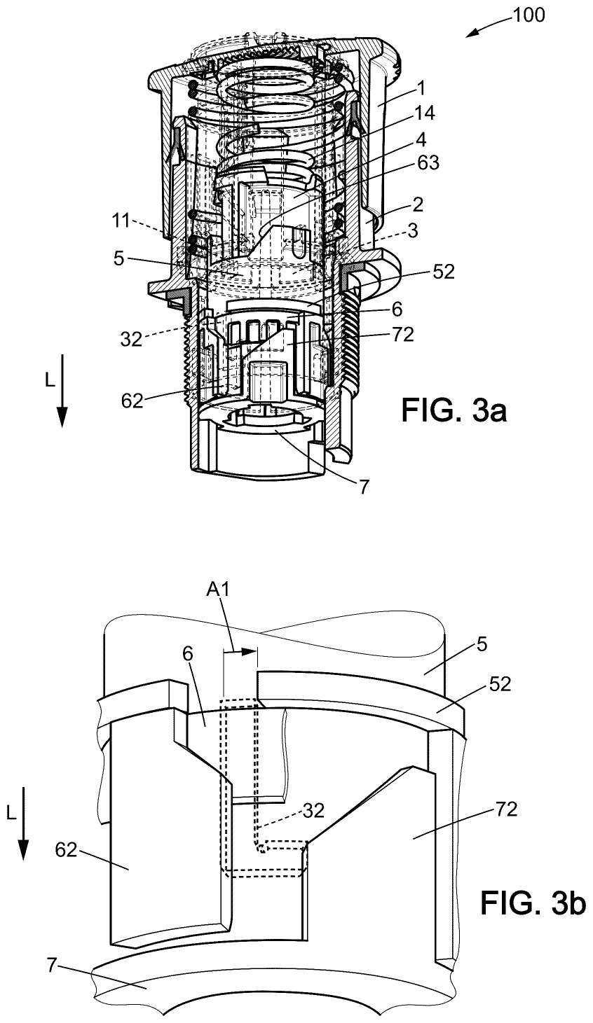

The user starts pressing the push-head 1 in the longitudinal direction L. Translation shift in the longitudinal direction L is transmitted to the plunger 4 through the trigger spring 14. The finger portion 11 of the push-head 1 contacts the slanted edge 53 of the cylinder 5 and makes this rotate against the torque produced by the latch spring 56. Energy is thus accumulated in the latch spring 56. This corresponds to an activation position of the push-button 100 as shown in FIGS. 3a and 3b. In this position, the rim segment 52 of the cylinder 5 has rotated so that it is no longer in line with the top end of the L-letter shape of the relief element 32, thus allowing the plunger sub-assembly 10 to start translating in the longitudinal direction L. Rotation of the cylinder 5 is indicated in FIG. 3b by tangential arrow A1.

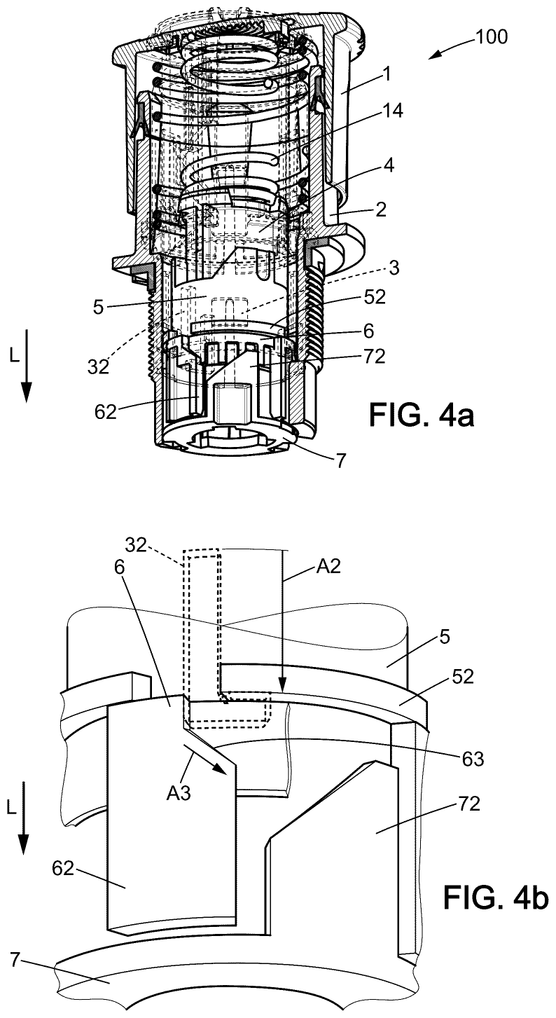

The further pressing the push-head 1 leads to the trigger position shown in FIGS. 4a and 4b. Due to the pressure of the trigger spring 14, the plunger sub-assembly 10 has translated in the longitudinal direction L until the rim segment 52 of the cylinder 5 abuts the small transverse bottom segment of the L-letter shape of the relief element 32. Such translation of the plunger sub-assembly 10 is indicated by longitudinal arrow A2 in FIG. 4b. Simultaneously, the torque produced by the latch spring 56 makes the latch part 6 to rotate toward the portion 72 of the ring 7, in accordance with the top edge 63 of the portion 62 as indicated by arrow A3.

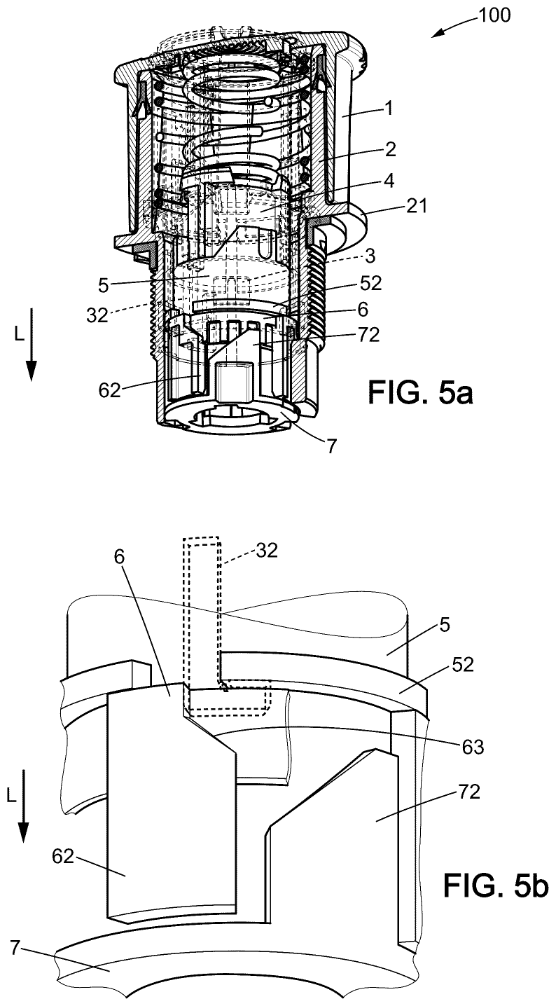

The push-head 1 stops moving forward when it abuts the stop ring 21 of the mount housing 2. This is the stop position shown in FIGS. 5a and 5b.

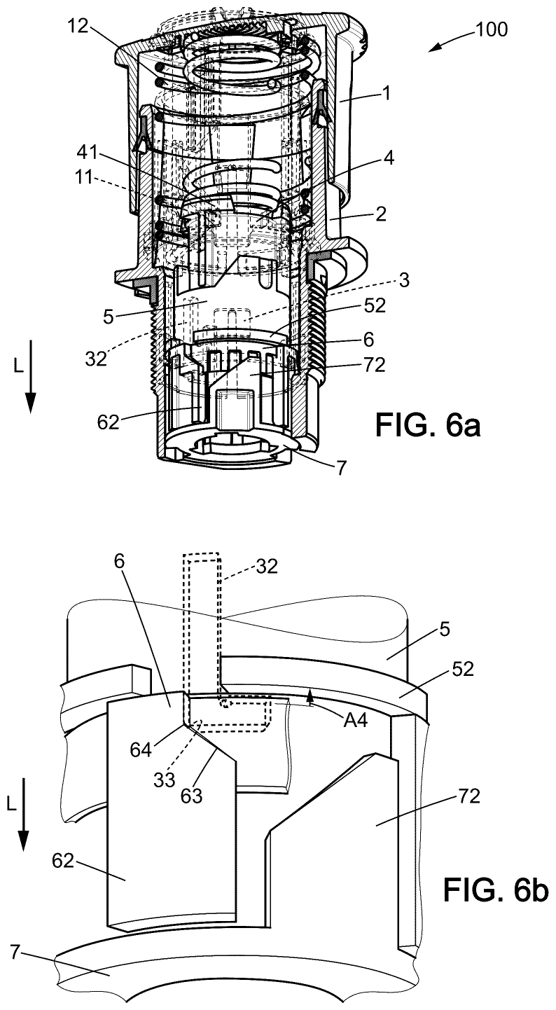

The user no longer presses the push-head 1. The pull-back spring 12 acting through the finger portion 11 of the push-head 1 hooking the rim segment 41 of the plunger 4 makes the plunger sub-assembly 10 move backward until the stop end 64 of the edge 63 of the latch part 6 abuts the external apex 33 of the relief element 32. Such backward shift of the plunger sub-assembly 10 may be any, in particular from about 0.5 mm (millimeter) to 2 mm, as indicated in FIG. 6b by longitudinal arrow A4. This is the locked position of the push-button 100 which is shown in FIGS. 6a and 6b. Locking is produced by the external apex 33 of the relief element 32 abutting the edge 63 of the latch part 6 at the stop end 64 of this edge. Activation of the push-button 100 from the off position into on-state is over.

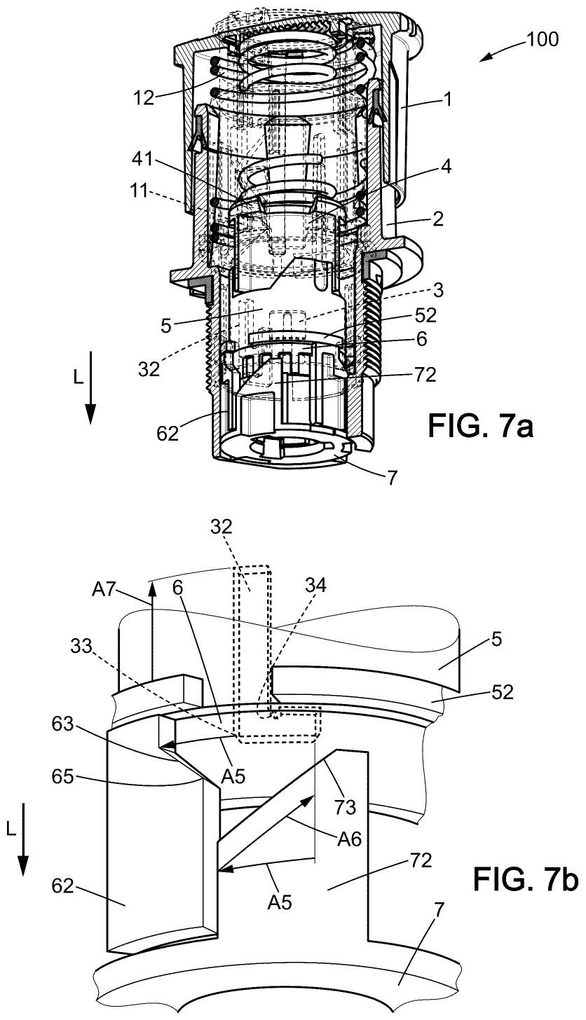

From this locked position, the user can bring back the push-button 100 into the off position by counter-rotating the push-head 1. Appropriate designs of the forward portion of the push-head 1 and of the plunger 4 transfer this counter-rotation from the push-head 1 to the plunger 4 and the ring 7, and the counter-rotation direction makes the portion 72 of the ring 7 to push in rotation the portion 62 of the latch part 6 against the torque produced by the latch spring 56, because the cylinder 5 remains blocked by its rim segment 52 abutting the internal apex 34 of the L-letter shape of the relief element 32. This leads to the rotation-unlocked position shown in FIGS. 7a and 7b. Counter-rotation of the latch part 6 is indicated by tangential arrow A5 in FIG. 7b. Once the escape end 65 of the latch part edge 63 has counter-rotated beyond the external apex 33 of the relief element 32, the pull-back spring 12 makes the plunger sub-assembly 10 move backward, again through the finger portion 11 of the push-head 1 hooking the rim segment 41 of the plunger 4. During this backward movement, slipping contact between the counter-slanted edge 73 of the ring 7 and the relief element 32 makes the ring 7 together with the plunger 4 rotate in the direction opposite to that applied just before by the user to the push-head 1, as indicated by oblique arrow A6. The push-button 1 thus moves back to the off position of FIGS. 2a and 2b as indicated by longitudinal arrow A7 in FIG. 7b.

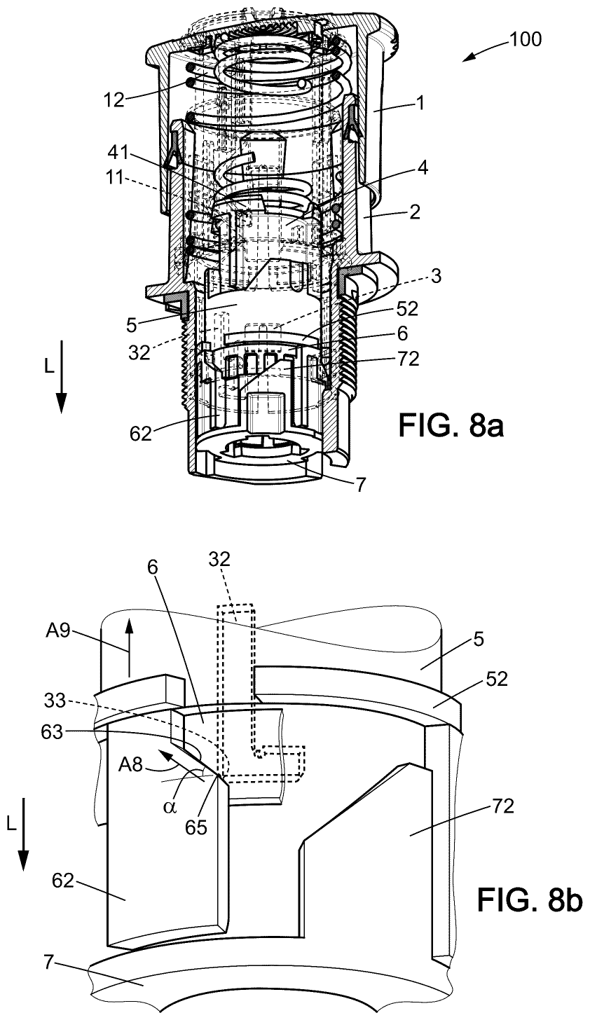

Again from the locked position of FIGS. 6a and 6b, and if the edge 63 of the latch part 6 is slanted relative to the longitudinal direction L, for example with angle value a from about 15° (degree) to about 45° in each plane tangential to the edge 63 and when measured from a tangential direction which is perpendicular to the longitudinal direction L (see in FIG. 8b), it is possible for the user to pull the push-head 1 with enough force for making the latch part 6 rotate against the torque produced by the latch spring 6, due to the slanted edge 63 slipping against the external apex 33 of the relief element 32. This slipping rotation of the latch part 6 in indicated by oblique arrow A8 in FIG. 8b and continues until the external apex 33 of the relief element 32 is reached by the escape end 65 of the latch part edge 63. FIGS. 8a and 8b illustrate such pull-unlocked position. Then, the backward translational movement of the plunger sub-assembly 10 continues thanks to the pull-back spring 12 until the off position of FIGS. 2a and 2b is recovered, as indicated by longitudinal arrow A9 in FIG. 8b.

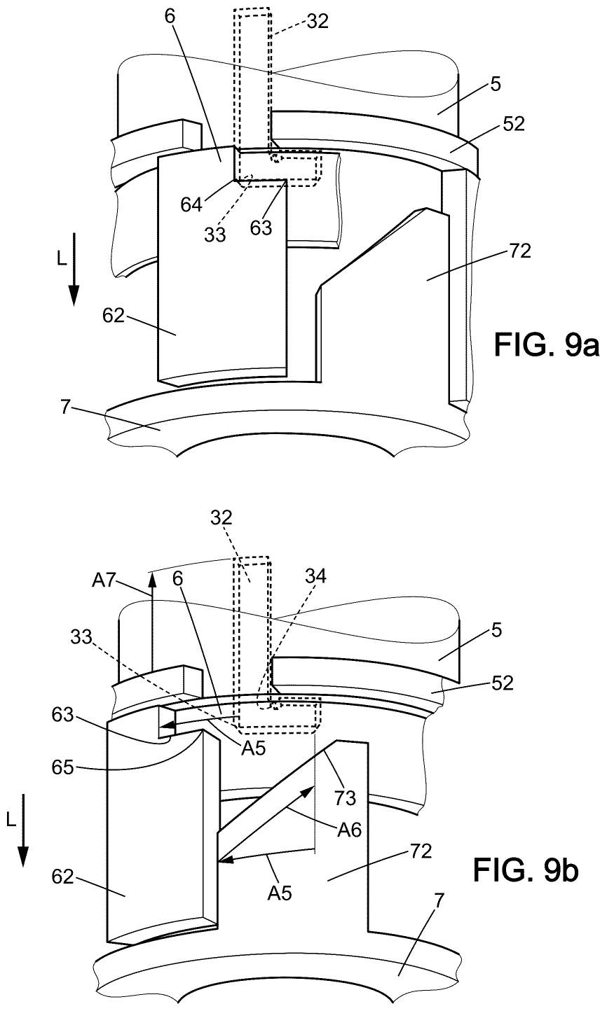

FIGS. 9a and 9b show that if the edge 63 of the latch part 6 is perpendicular to the longitudinal direction L, the unlocking of the push-button 100 through pulling of the push-head 1 by the user is no longer possible. The locked position of FIG. 9a can be released only by the user counter-rotating the push-head 1 as shown in FIG. 9b. FIG. 9b shows rotation-unlocking similar to FIG. 7b.

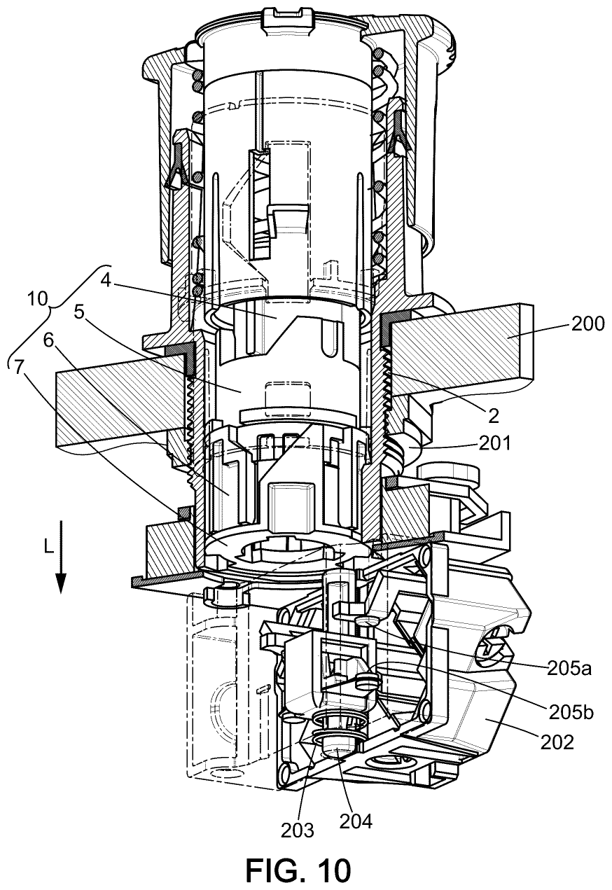

As shown in FIG. 10, an electrical system 200 is provided with a spring-loaded actuator 202. Only a limited part of a housing of the electrical system 200 is shown in this figure. This spring-loaded actuator 202 may be a normally-closed contact bloc. Reference number 203 denotes the spring internal to such actuator 202 which permanently pushes outwardly a movable rod 204. Electrical contact pads within the spring-loaded actuator 202 are denoted by reference signs 205a and 205b. The pad 205a is fixed and the pad 205b is supported by the movable rod 204 and thus pushed toward the fixed pad 205a by the spring 203. Such actuator 202 is designed for maintaining electrical supply to the electrical system 200 as long as the movable rod 204 is not pressed in the longitudinal direction L. The electrical system 200 may be a manufacturing machine for example. Its body is provided with a female threaded hub 201 in which the mount housing 2 of the push-button 100 is screwed-in. The hub 201 is located above the actuator 202 so that the plunger sub-assembly 10 contacts the movable rod 204 of this actuator 202. Thus, the push-button 100 adds a locking function to the open state in the operation of the actuator 202. An emergency shutdown key is thus provided to the electrical system 200, to be activated in emergency conditions and released by an operator when security is recovered.

Finally, il is reminded that all numeral values that have been mentioned in the above description are for exemplifying purpose only, and should not be considered limitedly in any case.

1. A push-button adapted for being pressed by a user parallel to a pressing direction, and for remaining in a locked pressed position until an unlocking action is executed by the user, where at least part of a plunger sub-assembly is driven into rotation by the user pressing a push-head of the push-button and the rotated part of the plunger sub-assembly then abuts a relief portion existing in an internal surface of a casing of said push-button, thereby producing locking of the pressed position,
wherein the plunger sub-assembly comprises:
a translation-to-rotation converting part, adapted for being rotated by the user pressing the push-head;
a latch part, having an edge arranged for abutting the relief portion in the internal surface of the casing so as to produce locking of the pressed position; and
a latch spring element separated from the translation-to-rotation converting part, and connecting the latch part to said translation-to-rotation converting part so that rotation of the translation-to-rotation converting part drives the latch part, through the latch spring element, into a position that leads to abutment of said latch part against the relief portion in the internal surface of the casing.

2. The push-button of claim 1, further comprising a pull-back spring intermediate between the push-head and the casing of the push-button, the pull-back spring being arranged so that the user pressing the push-head causes compression of said pull-back spring, and the compressed pull-back-spring then completes driving action of the latch spring element for producing the abutment of the latch part against the relief portion in the internal surface of the casing.

3. The push-button of claim 1, wherein the user pressing the push-head causes the plunger sub-assembly to translation-move in the pressing direction, said plunger sub-assembly comprising the following parts:
a center plunger, arranged for receiving a pressing force due to the user pressing the push-head, and for driving the plunger sub-assembly into translation movement;
the translation-to-rotation converting part, arranged around the center plunger and rotatable relative to said center plunger;
the latch part, also arranged around the center plunger and rotatable relative to said center plunger; and
the latch spring element,
wherein the center plunger, the translation-to-rotation converting part, the latch part and the latch spring element all execute a same translation movement component, parallel the pressing direction when the user presses the push-head.

4. The push-button of claim 3, wherein the latch spring element is a torsion spring which has turns arranged around the center plunger, between the translation-to-rotation converting part and the latch part.

5. The push-button of (100) of claim 3, further comprising a pull-back spring intermediate between the push-head and the casing of the push-button, the pull-back spring being arranged so that the user pressing the push-head causes compression of said pull-back spring, and the compressed pull-back-spring then completes driving action of the latch spring element for producing the abutment of the latch part against the relief portion in the internal surface of the casing, wherein the edge of the latch part is perpendicular to the pressing direction and extends between a re-entrant corner of said latch part and an escape end of said edge, so that the locked pressed position is produced by the abutment of the edge of the latch part at the re-entrant corner against an apex of the relief portion in the internal surface of the casing, and a counter-rotation of the plunger causes the latch part to rotation-slip on the relief portion until the escape end reaches the apex of said relief portion, thus allowing the pull-back spring to pull the plunger sub-assembly in a pull-back direction opposite the pressing direction.

6. The push-button of claim 5, wherein the push-head is arranged to contact the center plunger so that counter-rotation applied to said push-head by the user is transmitted to the center plunger.

7. The push-button of claim 5, wherein the center plunger is provided with a counter-slanted edge arranged for contacting another relief portion existing in the internal surface of the casing, and the pull-back spring pulling the center plunger in the pull-back direction causes said center plunger to rotate by the counter-slanted edge slipping on said another relief portion, against a return force produced by the latch spring element.

8. The push-button of claim 7, wherein the relief portion and said another relief portion belong to a same relief element located in the internal surface of the casing.

9. The push-button of claim 8, wherein the counter-slanted edge of the center plunger is arranged so that, when the pull-back spring pulls the plunger sub-assembly in the pull-back direction, the latch part and a forward portion of the center plunger that supports the counter-slanted edge both simultaneously slip along the relief element, on opposed edges of said relief element, while the latch spring element makes the latch part and the forward portion of the center plunger to pressure-sandwich the relief element.

10. The push-button of claim 3, further comprising a pull-back spring intermediate between the push-head and the casing of the push-button, the pull-back spring being arranged so that the user pressing the push-head causes compression of said pull-back spring, and the compressed pull-back-spring then completes driving action of the latch spring element for producing the abutment of the latch part against the relief portion in the internal surface of the casing, wherein the edge of the latch part is slanted with respect to the pressing direction and extends between a re-entrant corner of said latch part and an escape end of said edge, so that the locked pressed position is produced by the abutment of the edge of the latch part at the re-entrant corner against an apex of the relief portion in the internal surface of the casing, and so that a translation shift of the center plunger in a pull-back direction opposite the pressing direction causes the latch part to rotation-slip on the relief portion until the escape end reaches the apex of said relief portion, thus allowing the pull-back spring to further pull the plunger sub-assembly in the pull-back direction.

11. The push-button of claim 10, wherein the push-head is arranged to contact the center plunger so that a pull-shift applied to said push-head by the user is transmitted to the center plunger, so as to cause said center plunger to translate in the pull-back direction.

12. The push-button (100) of claim 1, further comprising a trigger spring which is intermediate between the push-head and the plunger sub-assembly, and arranged for transmitting at least part of a translation movement which is applied by the user to said push-head, in the pressing direction, to said plunger sub-assembly.

13. The push-button of claim 1, wherein the push-head, the plunger sub-assembly and the internal surface of the casing are designed for remaining identical through rotations of 120° about an axis that is parallel to the pressing direction.

14. An electrical system, comprising a spring-loaded actuator designed for being operated through pressing onto said actuator by a user, and further comprising a push-button according to claim 1, the push-button being arranged overtop the actuator so as to provide a locking function to a pressed state of the actuator.

15. The electrical system of claim 14, wherein the actuator and the push-button form a shutdown key of the electrical system.
